(19) United States
(12) Patent Application Publication
(10) Pub. No.: US 2026/0267510 A1
(43) Pub. Date: Sep. 10, 2026

(54) CONTROLLER AND STORAGE DEVICE INCLUDING DATA STRUCTURE INFORMATION CORRESPONDING TO MAP DATA

(71) Applicant: SK hynix Inc., Icheon-si (KR)

(72) Inventors: Jung Ho HAN, Icheon-si (KR); Jin Hyeok YANG, Icheon-si (KR); Young Il CHUN, Icheon-si (KR)

(21) Appl. No.: 19/248,215

(22) Filed: Jun. 24, 2025

(30) Foreign Application Priority Data
Mar. 4, 2025 (KR) 10-2025-0027294

(51) Int. Cl. G06F 3/06

(52) U.S. Cl. CPC G06F 3/061; G06F 3/0659; G06F 3/0673

(57) ABSTRACT

Embodiments of the present disclosure configures data structure information corresponding to map data representing mapping relationships between logical addresses by a host device and physical addresses of a memory in a binary search tree structure, and manages and searches for the map data on the basis of the data structure information, thereby reducing the time required for searching for the map data and thus improving the operational performance of a storage device including the memory that processes a command from the host device.

### CROSS-REFERENCE TO RELATED APPLICATION

The present application claims priority under 35 U.S.C. §119(a) to Korean Patent Application No. 10-2025-0027294 filed in the Korean Intellectual Property Office on March 4, 2025, which is incorporated herein by reference in its entirety.

### BACKGROUND

### 1. Technical Field

Embodiments of the present disclosure generally relate to a controller and a storage device.

### 2. Related Art

A storage device may include at least one memory that stores data. The storage device may include a controller that controls the operation of the memory. For example, the controller may control the operation of the memory according to a command received from an external device and perform data processing according to the command.

In order to process a command from the external device, the controller may manage a mapping relationship between a logical address sent by the external device and a physical address indicating a storage area included in the memory. When receiving the logical address according to the command from the external device, the controller may instruct and control an operation according to the command for the physical address corresponding to the logical address.

When the controller checks the mapping information between the logical address and the physical address when processing the command from the external device, processing of the command may be delayed and the operational performance of the storage device may deteriorate.

### SUMMARY

Objects of embodiments of the disclosure are not limited to those set forth herein, and other objects not mentioned will be apparent to one of ordinary skill in the art from the following description.

Various embodiments of the present disclosure are directed to providing measures for efficiently managing mapping information between a logical address received by a storage device from an external device and a physical address of a memory, thereby reducing the time required to process a command from the external device and improving the operational performance of the storage device.

In an embodiment, a storage device may include: a memory including a plurality of storage areas, each of the plurality of storage areas indicated by a physical address; and controller configured to load a map data representing a mapping relationship between the physical address and a logical address provided by a host device and data structure information corresponding to the map data into a sub memory, and to search for the map data using the data structure information, which includes a validity field that has a value indicating whether the map data is valid.

In an embodiment, a storage device may include: a first memory including a plurality of storage areas indicated by physical addresses; a second memory including a first data area and a second data area, wherein data structure information having at least one pointer value is stored in the first data area and map data, corresponding to the data structure information and including the physical addresses, is stored in the second data area; and a controller configured to search for the map data using the data structure information.

In an embodiment, a controller may include: a sub memory including a first data area and a second data area, wherein data structure information having at least one pointer value is stored in the first data area and map data corresponding to the data structure information is stored in the second data area; and a search engine configured to search for the map data using the data structure information.

According to the embodiments of the present disclosure, a storage device may manage map data using data structure information corresponding to the map data, thereby reducing the time required for searching, updating, etc. of the map data and providing a storage device with improved data processing performance.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a diagram illustrating an example of a schematic configuration of a storage device according to embodiments of the present disclosure.

FIG. 2 is a diagram illustrating an example of a schematic configuration of a controller included in a storage device according to embodiments of the present disclosure.

FIGS. 3 to FIG. 5 are diagrams illustrating examples of data structure information and map data loaded into a sub memory by a controller according to embodiments of the present disclosure.

FIG. 6 is a diagram illustrating an example of data structure information managed by a search engine included in a controller according to embodiments of the present disclosure.

FIG. 7 is a diagram illustrating examples of modes in which a search engine searches for map data according to embodiments of the present disclosure.

FIG. 8 is a diagram illustrating an example of a structure of a search engine according to the embodiments of the present disclosure.

FIG. 9 is a diagram illustrating an example of a state related to an operation in which a search engine inserts a node into a data structure according to embodiments of the present disclosure.

FIG. 10 is a diagram illustrating an example of a state related to an operation in which a search engine searches for a node in a data structure according to embodiments of the present disclosure.

FIG. 11 is a diagram illustrating an example of a state related to an operation in which a search engine deletes a node from a data structure according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element may be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, or manufacturing methods, these terms may be used to describe non-consecutive or non-sequential processes or operations unless the term "directly" or "immediately" is used together.

In addition, when any dimensions, relative sizes etc. are mentioned, it should be considered that numerical values for elements or features, or corresponding information (e.g., level, range, etc.) include a tolerance range or error margin that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

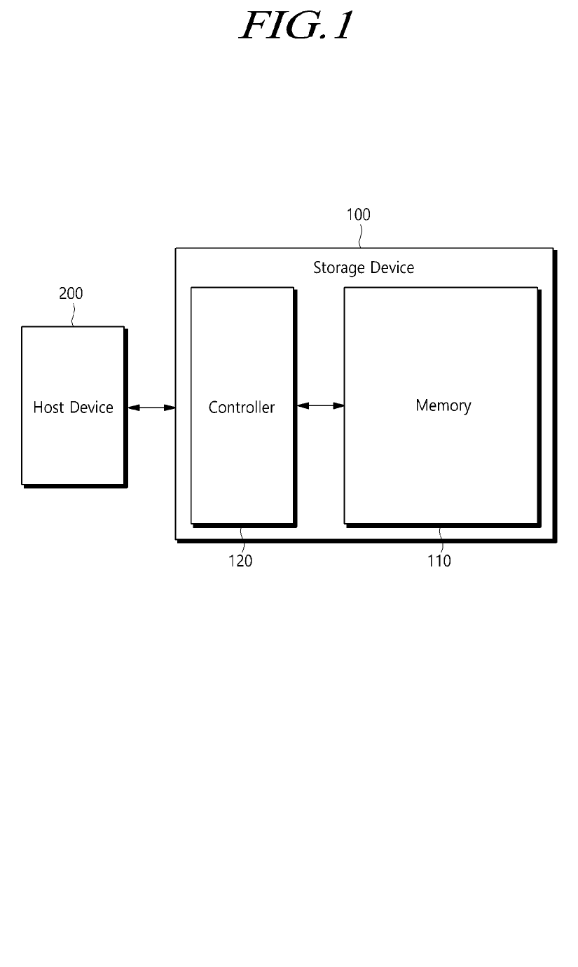

FIG. 1 is a diagram illustrating an example of a schematic configuration of a storage device 100 according to embodiments of the present disclosure.

Referring to FIG. 1, a storage device 100 according to the embodiments of the present disclosure may include at least one memory 110. The storage device 100 may include a controller 120 that controls the operation of the memory 110.

The memory 110 may be nonvolatile memory such as, for example, NAND flash memory, 3D NAND flash memory or NOR flash memory, but the embodiments of the present disclosure are not limited thereto. As the case may be, the memory 110 may be volatile memory such as DRAM, SDRAM, DDR SDRAM or LPDDR SDRAM. One part of the memory 110 included in the storage device 100 may be volatile memory, and the other part may be nonvolatile memory. When volatile memory and nonvolatile memory are included in the storage device 100, the two types of memory 110 may be used for the same function. Alternatively, one type (e.g., volatile) of memory 110 may be used for an operation required in the process of storing data in the other type (e.g., nonvolatile) of memory 110.

In addition, the memory 110 may be one of various types of memory such as resistive RAM, phase change memory, magnetoresistive memory, ferroelectric memory or spin transfer torque memory. The memory 110 may be a processing-in-memory that includes a computation function or a data processing function, and the type of the memory 110 included in the storage device 100 according to embodiments of the present disclosure may vary.

The memory 110 may include a plurality of storage blocks. Each of the plurality of storage blocks may include a plurality of memory cells. Two or more memory cells may constitute one page, and a plurality of pages may constitute one storage block.

The controller 120 may receive a command from the outside, and may control the operation of the memory 110 on the basis of the received command. In addition, the controller 120 may control the operation of the memory 110 on the basis of an internally generated command. In the present specification, a command that the controller 120 receives from the outside may be referred to as an external command, and a command that is generated inside the controller 120 may be referred to as an internal command.

A controller 120 may control the operation of the memory 110 on the basis of the external command or the internal command. For example, the controller 120 may control an operation of writing data to the memory 110. The controller 120 may control an operation of reading data written to the memory 110. Data may be transmitted and received between the controller 120 and the memory 110.

Depending on the type of the memory 110, the controller 120 may control a data preservation operation (e.g., a refresh operation or a patrol scrub operation) or an erase operation on data written to the memory 110.

In order to maintain or improve the operational performance of the storage device 100, the controller 120 may perform a background operation related to the memory 110 on the basis of an external command received from an external host device 200 or an internal command. The background operation may include at least one among, for example, garbage collection, wear leveling, read reclaim and bad block management operations. Through control of the background operation, the controller 120 may improve the operational performance of the storage device 100 or prevent the operational performance of the storage device 100 from deteriorating.

The controller 120 may control the operation of the memory 110 on the basis of a command received from the host device 200. The controller 120 may provide the host device 200 with a processing result according to an operation corresponding to the command. The controller 120 may transmit data or a response signal to the host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, a radio frequency identification (RFID) device, a mobility device (e.g., a vehicle, a robot or a drone) capable of traveling under human control or autonomous driving, etc. Alternatively, the host device 200 may be a virtual/augmented reality device that provides a 2D or 3D virtual reality image or augmented reality image. Besides, the host device 200 may be any one of various electronic devices, each of which requires the storage device 100 capable of storing data.

The host device 200 may include at least one operating system. The operating system may manage and control overall functions and operations of the host device 200, and may control the interoperation between the host device 200 and the storage device 100. The operating system may be classified into a general operating system and a mobile operating system depending on the mobility of the host device 200.

The controller 120 and the host device 200 may be devices that are separated from each other. As the case may be, the controller 120 and the host device 200 may be implemented by being integrated as one device, or some components or functions of the controller 120 may be implemented by being included in the host device 200. In the following, for the sake of convenience in explanation, examples assume that the controller 120 and the host device 200 are devices that are separated from each other will be described, but the embodiments of the present disclosure are not limited thereto.

According to a command received from the host device 200, the controller 120 may control an operation of storing data in the memory 110 or reading or deleting data stored in the memory 110. The controller 120 may receive a logical address according to the command. The logical address or a logical block address may be an address that is managed by the host device 200.

The controller 120 may map the logical address from the host device 200 to a physical address indicating a storage area of the memory 110. The controller 120 may perform an operation according to the command on the storage area indicated by the physical address, which is mapped to the logical address according to the command.

For example, the controller 120 may store and manage, in the memory 110, mapping information representing a mapping relationship between a logical address and a physical address. In addition, in order to quickly process an operation according to a command, the controller 120 may load and use mapping information, stored in the memory 110 into and in another type of storage area, to perform data processing.

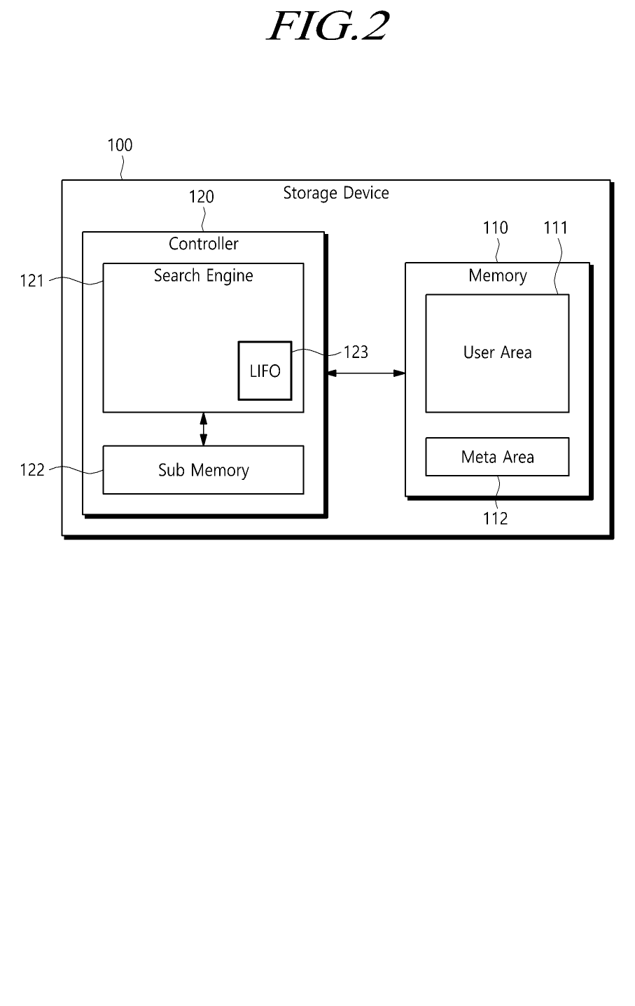

FIG. 2 is a diagram illustrating an example of a schematic configuration of a controller included in a storage device according to embodiments of the present disclosure.

Referring to FIG. 2, in order to process data according to a command from a host device 200, a controller 120 of a storage device 100 may manage and use mapping information or map data representing the mapping relationship between a logical address from the host device 200 and a physical address of a memory 110. The controller 120 may store and use the map data in the memory 110. Alternatively, the controller 120 may store and use the map data in another type of storage area other than the memory 110.

For example, the controller 120 may store and manage the map data in a partial storage area of the memory 110. The memory 110 may include storage areas that are distinguished depending on the type of data to be stored. For example, the memory 110 may include a user area 111 and a meta area 112.

The user area 111 may be an area where user data according to a request from the host device 200 is stored. A logical address from the host device 200 and a physical address indicating a unit storage area included in the user area 111 may be mapped to each other, and mapping information may be managed by the controller 120.

The meta area 112 may be an area where the controller 120 stores various metadata required to control or manage the operation of the memory 110.

For example, map data representing the mapping relationship between a logical address from the host device 200 and a physical address of the memory 110 may be stored and managed in the meta area 112. The meta area 112 may also be used as an area for temporarily storing user data when performing a background operation such as garbage collection.

The meta area 112 may be an area that is not accessible by the host device 200. The meta area 112 may be accessed only by the controller 120, and the controller 120 may store various information necessary to control the memory 110, by using the meta area 112.

The controller 120 may load and use map data stored in the meta area 112 of the memory 110 with another storage area located outside the memory 110. For example, the controller 120 may load the entirety or a part of the map data into a working memory located outside the memory 110, and may use the entirety or a part of the map data loaded into the working memory to check the mapping information between a logical address and a physical address.

The working memory may be a type of memory different from the memory 110. For example, the memory 110 may be nonvolatile memory, and the working memory may be volatile memory. The working memory may be a type of memory that has a faster access speed than the type of memory in the memory 110. In the present specification, the memory 110 may be referred to as a first memory, and the working memory outside of the memory 110 into which map data is loaded may be referred to as a second memory.

The working memory may be located outside the controller 120 or may be located inside the controller 120. FIG. 2 illustrates, as an example, a working memory into which map data is loaded located inside the controller 120, but embodiments of the present disclosure are not limited thereto.

The controller 120 may include an interface for communication with the host device 200 or the memory 110. The controller 120 may include a control logic that processes a command from the host device 200 and controls the operation of the memory 110. The controller 120 may include a storage area for storing information necessary for control. For example, the controller 120 may include a sub memory 122.

The sub memory 122 may be, for example, volatile memory such as SRAM, but embodiments of the present disclosure are not limited thereto. The storage area of the sub memory 122 may be allocated to store various information required for control by the controller 120. For example, at least a partial storage area of the sub memory 122 may be allocated to store map data. The entirety of the map data stored in the memory 110 may be loaded into the sub memory 122 and used, or a part of the map data may be loaded into the sub memory 122 and used. The controller 120 may load map data into the sub memory 122 and use the map data, update the map data, and may store the updated map data in the memory 110.

The controller 120 may include a search engine 121 for searching and managing map data stored in the sub memory 122. The search engine 121 may be implemented in the form of a logic in the controller 120, but in other embodiments the logic may be implemented separately from the control logic, etc. of the controller 120. The controller 120 may be implemented in the form of a single chip. However, at least some of the control logic, the interface, the search engine 121, the sub memory 122, etc. may be implemented in the form of chiplets, and a plurality of chiplets may be connected together to configure the controller 120.

The search engine 121 may search for or manage a physical address mapped to a logical address according to a command from the host device 200 using map data loaded into the sub memory 122. The search engine 121 or the control logic of the controller 120 may load the entirety or a part of map data into the sub memory 122, and may use the entirety or the part of the map data to process a command from the host device 200.

The search engine 121 may include a buffer memory 123 that stores information or data required to search for or manage map data. The buffer memory 123 may have, for example, a LIFO (last input first out) stack structure, but embodiments are not limited thereto. For example, a storage area located outside the search engine 121 may be used as the buffer memory 123.

The search engine 121 may generate and manage data structure information corresponding to map data loaded into the sub memory 122 to easily perform search or management on the map data. The search engine 121 may load the data structure information corresponding to the map data into the sub memory 122 and use the data structure information. The data structure information may be, for example, a binary search tree structure, but examples are not limited thereto.

The search engine 121 may manage and search for map data using data structure information, thereby reducing the time required to manage or search for the map data. By reducing the time required for data processing using map data, the operational performance of the storage device 100 that processes a command from the host device 200 may be improved.

Data structure information corresponding to map data may be configured in various ways, and may be configured to minimize the size of the map data according to the data structure information loaded into the sub memory 122.

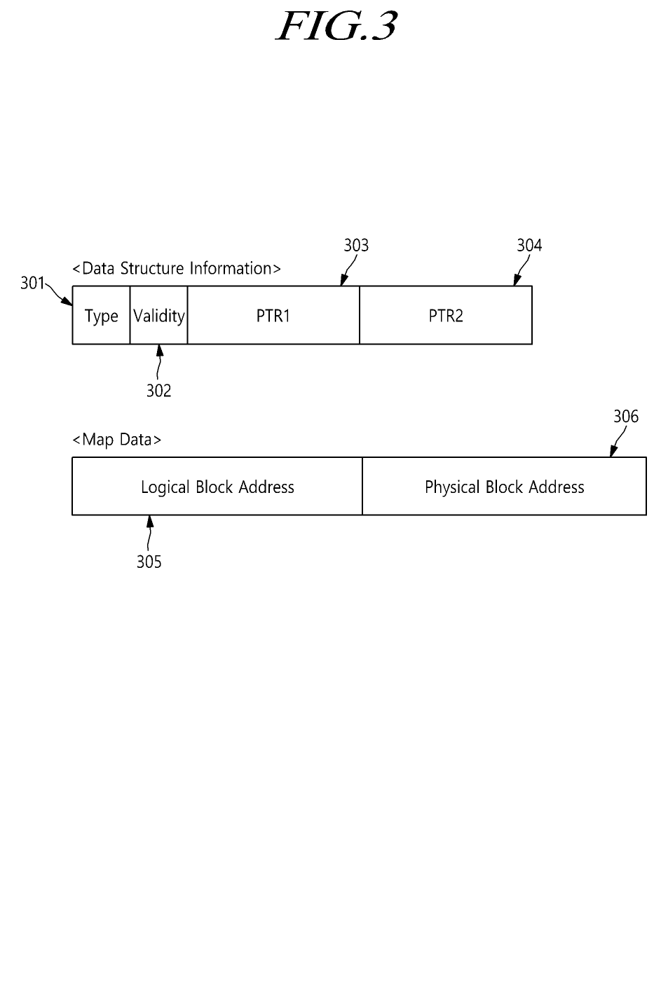

FIGS. 3 to FIG. 5 are diagrams illustrating examples of data structure information and map data loaded into a sub memory by a controller according to embodiments of the present disclosure.

Referring to FIG. 3, a controller 120 may manage data structure information corresponding to map data. The data structure information may be generated and managed, for example, by a control logic or search engine 121 of the controller 120.

Data structure information may correspond to map data. Data structure information may include, for example, information corresponding to each node according to a binary search tree. The data structure information may include various information on each node.

For example, data structure information may include a type field as indicated by 301. The type field may indicate the type of the data structure information. For example, when the data structure information corresponds to a binary search tree structure such as a red-black tree, the type field may have a value indicating information on a color such as red or black. For example, when the value of the type field is ‘0,’ red may be indicated, and when the value of the type field is ‘1,’ black may be indicated, but embodiments of the present disclosure are not limited thereto.

The data structure information may include a validity field as indicated by 302. The validity field may have a value indicating whether map data corresponding to the data structure information is valid. For example, when the value of the validity field is ‘0,’ the value may indicate that the map data corresponding to the data structure information is invalid, and when the value of the validity field is ‘1,’ the value may indicate that the map data corresponding to the data structure information is valid, but embodiments of the present disclosure are not limited thereto.

Since whether map data is valid or not may be indicated by the validity field, a time point at which map data is updated and a time point at which data structure information is updated may be independently controlled.

For example, when only the value of the validity field of the data structure information is updated, map data corresponding to the data structure information may be maintained without being changed. The map data corresponding to the data structure information may be updated along with deletion of the corresponding data structure information during a preset period. By updating the validity field independently, the map data may be managed and used while the time delay due to changes in the map data is reduced.

The data structure information may include at least one pointer field that has a pointer value associated with the data structure information.

For example, the data structure information may include a first pointer field as indicated by 303. The data structure information may include a second pointer field as indicated by 304.

The first pointer field may have a first pointer value associated with the data structure information. The second pointer field may have a second pointer value associated with the data structure information.

When the data structure information is information according to a binary search tree structure, the first pointer value and the second pointer value may be pointer values that indicate child nodes. For example, the first pointer value may indicate a first child node, and the second pointer value may indicate a second child node. The value of the second child node may be greater than the value of the first child node.

The first pointer value may indicate the address of the data structure information that includes the first pointer field. When the data structure information is loaded into the sub memory 122, the first pointer value may indicate the sub memory address of the corresponding data structure information. The second pointer value may indicate the address of next data structure information of the data structure information including the second pointer field. The second pointer value may indicate a sub memory address where the next data structure information of the corresponding data structure information is stored.

As in the example described above, the data structure information may include the type field, the validity field, the first pointer field and the second pointer field, and the size of the data according to the data structure information loaded into the sub memory 122 may be minimized.

Map data may include mapping information between a logical address from the host device 200 and a physical address of the memory 110, and may be configured in various forms.

For example, as indicated by 305, the map data may include a field that stores a logical address (or a logical block address). As indicated by 306, the map data may include a field that stores a physical address (or a physical block address). The map data may represent the mapping relationship between the logical address from the host device 200 and the physical address of the memory 110, and as the case may be, may further include other information related to the logical address or the physical address.

The controller 120 may load the map data into the sub memory 122, and may use the map data when processing a command by the host device 200. The controller 120 may load the data structure information corresponding to the map data into the sub memory 122 and use the data structure information along with the map data in the sub memory 122. The controller 120 may load the data structure information into an area allocated for data structure information in the sub memory 122. The controller 120 may load the map data into an area allocated for map data in the sub memory 122. The area allocated for data structure information and the area allocated for map data may be distinguished from each other.

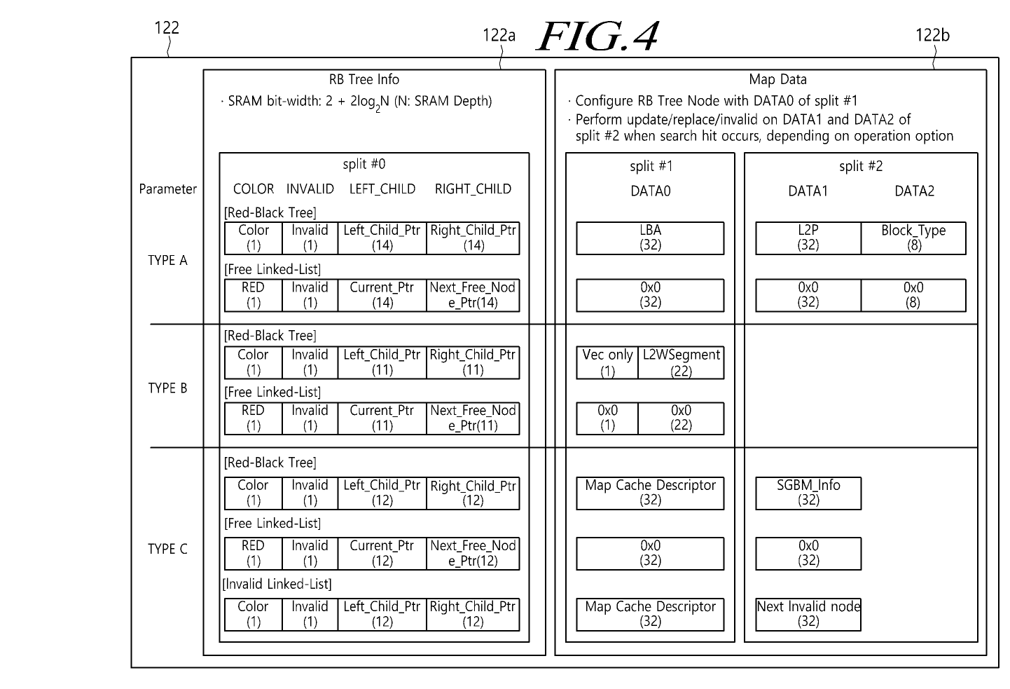

For example, referring to FIG. 4, a sub memory 122 may include a first data area 122a and a second data area 122b. The first data area 122a may be an area into which data structure information is loaded. The second data area 122b may be an area into which map data is loaded.

At least a part of the first data area 122a or the second data area 122b may be managed by being further divided into at least two areas. For example, the first data area 122a may be managed as one area that is identified as split #0. The second data area 122b may be managed as two areas that are identified as split #1 and split #2, but embodiments of the present disclosure are not limited thereto.

The controller 120 may load data structure information into the first data area 122a, and may load map data corresponding to the data structure information into the second data area 122b. Depending on the type of search engine 121 or the type of map data, map data loaded into the second data area 122b may be different. Data structure information corresponding to map data may also be different depending on the type of the search engine 121, etc.

For example, when the search engine 121 is TYPE A, data structure information may include a type field, a validity field, a first pointer field and a second pointer field. The type field may have a value corresponding to 1 bit. The validity field may have a value corresponding to 1 bit. Each of the first pointer field and the second pointer field may have a value corresponding to 14 bits.

When the search engine 121 is TYPE B, the type field, the validity field, the first pointer field and the second pointer field of data structure information may have values corresponding to 1 bit, 1 bit, 11 bits and 11 bits, respectively. When the search engine 121 is TYPE C, the type field, the validity field, the first pointer field and the second pointer field of data structure information may have values corresponding to 1 bit, 1 bit, 12 bits and 12 bits, respectively.

The numbers of bits of the respective fields of data structure information described above are representative examples, and the sizes of respective fields included in data structure information may be variously set depending on the search engine 121.

When the search engine 121 is TYPE A, map data corresponding to the data structure information may include, for example, a field having LBA, a field having L2P and a field having Block_Type. LBA may mean a logical address, and the field having LBA may have a value corresponding to 32 bits. L2P may mean a physical address corresponding to the logical address, and the field having L2P may have a value corresponding to 32 bits. Block_Type may represent the type of a block corresponding to the physical address. For example, Block_Type may indicate whether the corresponding block is a free block that is not programmed, an open block that is being programmed or a closed block that is completely programmed, but examples are not limited thereto. The field having Block_Type may have a value corresponding to 8 bits.

A logical address from the host device 200 may be stored in the split #1 area in the second data area 122b where map data is stored, and a logical address or a block type related to the memory 110 may be stored in the split #2 area in the second data area 122b. The initial value of each field may be set to, for example, 0x0 as in FIG. 4.

Depending on the type of the search engine 121, map data stored in the second data area 122b may vary. For example, as in the case of TYPE B, map data may be stored only in the area corresponding to split #1 in the second data area 122b. Alternatively, as in the case of TYPE C, map data may be stored in the area corresponding to split #1 and a part of the area corresponding to split #2 in the second data area 122b.

The form of map data stored in the second data area 122b may vary, and data structure information corresponding to the map data may be stored and used in the first data area 122a, which is distinguished from the second data area 122b.

When changing data structure information, the controller 120 may perform the change of data structure information while accessing only the first data area 122a without accessing the second data area 122b. Since the controller 120 may separately perform updates of data structure information and map data, the controller 120 may perform an operation while using only the bandwidth corresponding to the first data area 122a, for example. An update or management operation on map data may be efficiently performed by management using the data structure information. For example, the validity field of the data structure information may be updated without changing map data corresponding to the data structure information. By a value of the validity field of the data structure information, map data corresponding to the data structure information may be indicated as an invalid map data. A update of map data may be performed independently from the update of the data structure information or later, and thus the update or management operation on map data may be performed efficiently.

Data loaded into the first data area 122a and the second data area 122b may be set to initial values during the initial operation of the sub memory 122.

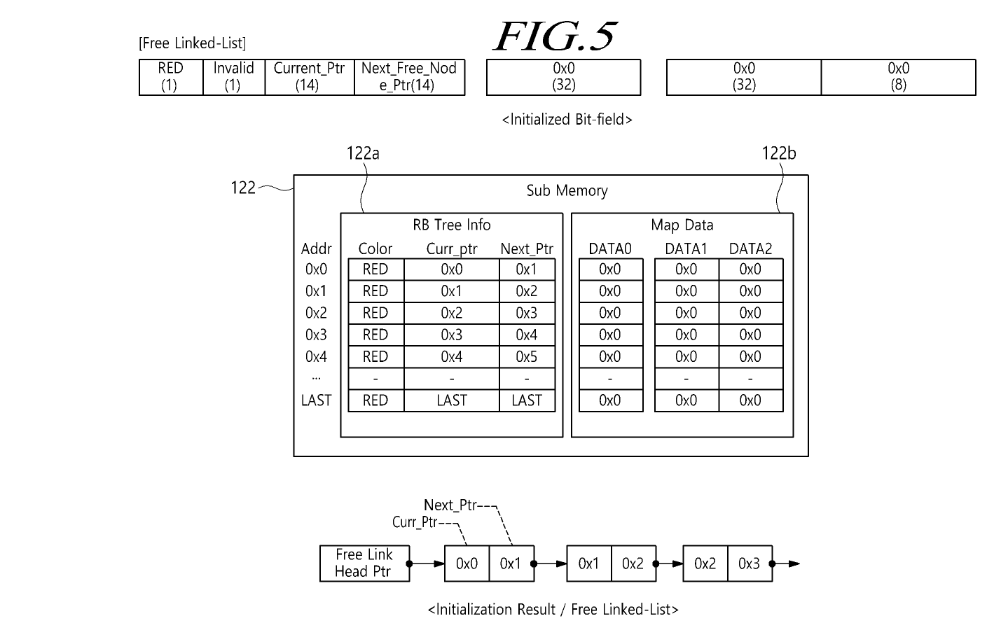

For example, referring to FIG. 5, data structure information may be set in a first data area 122a of a sub memory 122, and map data may be set in a second data area 122b of the sub memory 122. Each piece of the data structure information of the first data area 122a and each piece of the map data of the second data area 122b may be indicated by a sub memory address according to the sub memory 122.

The type field and the validity field of the data structure information may have the value of ‘0’ or ‘1’ as an initial value. The first pointer field of the data structure information may have, as an initial value, the sub memory address of the data structure information including the first pointer field. For example, the value of the first pointer field of data structure information corresponding to a sub memory address 0x0 may be 0x0. The second pointer field of the data structure information may have, as an initial value, the sub memory address of next data structure information of the data structure information including the second pointer field. For example, the value of the second pointer field of the data structure information corresponding to the sub memory address 0x0 may be 0x1. 0x1 may be the sub memory address of the next data structure information after sub memory address 0x0.

Map data may have a preset value as an initial value. For example, map data stored in the second data area 122b may be set to 0x0, but is not limited thereto.

During an initial operation of the sub memory 122, data structure information and map data may be set to initial values, and the data structure information may be updated as a result of loading of map data. Map data and data structure information corresponding to the map data may be updated according to a command from a host device 200. Map data may also be managed without changing the map data when the data structure information is updated. In addition, by managing data structure information in a binary search tree structure, the time required for searching for and updating map data may be reduced. A binary search tree used as data structure information may vary, but as an example, a binary search tree may have a red-black tree structure.

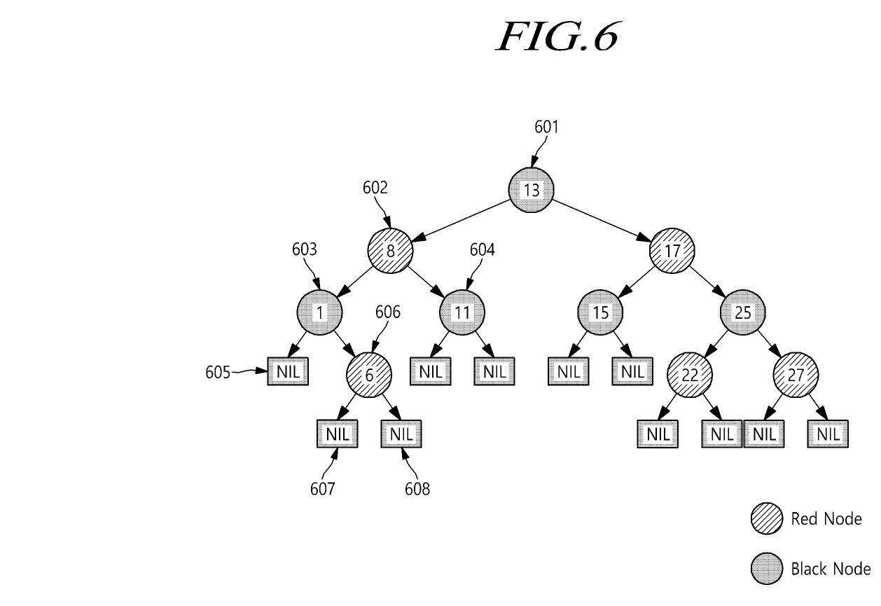

FIG. 6 is a diagram illustrating an example of data structure information managed by a search engine included in a controller 120 according to embodiments of the present disclosure.

Referring to FIG. 6, data structure information may be configured, for example, in a red-black tree structure. FIG. 6 illustrates, as an example, the value of each node of the red-black tree structure, and each node of the red-black tree structure used by a search engine 121 may correspond to map data. In addition, although a case where data structure information according to an embodiment of the present disclosure is configured in a red-black tree structure is described, other embodiments of the present disclosure may also be applied to various binary search tree structures.

A red-black tree basically has attributes of a binary search tree, and may additionally satisfy the following conditions.

In a red-black tree structure, the colors of all nodes may be either red or black. The color of a root node may always be black. As indicated by 601, in FIG. 6 the root node is a black node. The color of all leaf nodes NIL may be black. As indicated by 607 and 608, in FIG. 6 all leaf nodes are black nodes.

At least one of the first pointer value of the first pointer field of the data structure information of a leaf node or the second pointer value of the second pointer field of the data structure information of the leaf node may have a value indicating a leaf node. For example, at least one of the first pointer value or the second pointer value may be a sub memory address of a leaf node. Alternatively, the first pointer value and the second pointer value may have the same value. Leaf nodes may be distinguished by a first pointer value and a second pointer value. Because the data structure information does not include a separately field for identifying a leaf node, the size of data according to the data structure information may be minimized.

The child nodes of a red node may always be black nodes. Due to this fact, red nodes may not appear in consecutive levels of the tree structure. As indicated by 602, in FIG. 6 the child node of the root node is a red node. As indicated by 603 and 604, in FIG. 6 the child nodes of the red node are black nodes. The node indicated by 603 is the first child node of the node indicated by 602, and may have a value smaller than the node indicated by 602. The node indicated by 604 is the second child node of the node indicated by 602, and may have a value greater than the node indicated by 602.

The color of each node may be indicated by the type field included in data structure information. For example, the type field of the data structure information corresponding to the node indicated by 602 may have a first value. The type fields included in the data structure information corresponding to the first child node and the second child node of the node indicated by 602 may both have a second value. Since red nodes do not appear in consecutive levels of the tree structure, the type fields included in the child node and the parent node of the node indicated by 602 may both have the second value.

Among the child nodes of the node indicated by 603, the node indicated by 605 may be a leaf node, which is a black node. Among the child nodes of the node indicated by 603, the node indicated by 606 may be a red node. The child nodes of the node indicated by 606 may all be leaf nodes, and therefore black nodes.

The same number of black nodes may be found along every path that extends from any node to a leaf node which is positioned lower than the any node.

Because red nodes do not appear in consecutive levels of the tree structure, and because the same number of intermediate black nodes are on every path extending from any node to a leaf nodes, even when the distance from a root node to a leaf node is at its longest, the distance does not exceed twice the distance of a shortest path. With data structure information configured in the form of a red-black tree structure, the time required to search for map data may be reduced.

By using data structure information configured in a red-black tree structure, the search engine 121 may easily perform searching for map data corresponding to the data structure information. In addition, as the case may be, the search engine 121 may search for map data in a different search mode depending on the type of searching for map data.

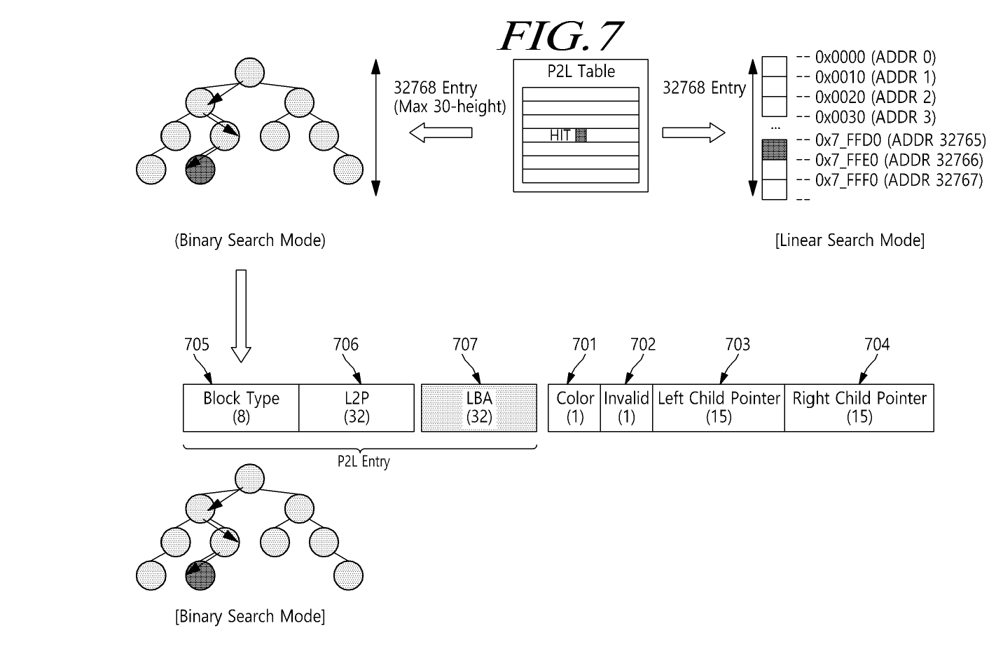

FIG. 7 is a diagram illustrating examples of modes in which a search engine searches for map data according to embodiments of the present disclosure.

Referring to FIG. 7, a search engine 121 may search for map data in a binary search mode using data structure information configured with a binary search tree. Alternatively, the search engine 121 may search for map data in a linear search mode in a mapping table configured with map data.

For example, when searching for specific map data or a single map data, the search engine 121 may search for the map data using the binary search mode.

The search engine 121 may check the values of a type field indicated by 701 and a validity field indicated by 702 in data structure information configuring a binary search tree. When the map data corresponding to the data structure information is valid, the search engine 121 may check the map data corresponding to the data structure information.

The search engine 121 may check a logical address indicated by 707 in the map data. When the checked logical address corresponds to the sought for logical address, the search engine 121 may check the information on a corresponding physical address indicated by 706 and a block type indicated by 705.

When the logical address checked in the map data does not correspond to the sought for logical address, the search engine 121 may check the first pointer value of a first pointer field indicated by 703 or the second pointer value of a second pointer field indicated by 704. For example, the search engine 121 may select data structure information to be searched for next using the first pointer value or the second pointer value, depending on the size relationship between the checked logical address and the logical address to be searched for.

The search engine 121 may more easily search for a physical address mapped to the sought for logical address by using data structure information according to a binary search tree structure.

When searching for map data included within a range of map data, the search engine 121 may search for the map data in a mapping table using a linear search mode. The search engine 121 may search for map data without using data structure information according to a binary search tree structure. The search engine 121 may search for map data by configuring data structure information corresponding to the map data in a binary search tree structure, thereby reducing the time required for a search. Thus, the search engine may search for the map data using one of the binary search mode and the linear search mode depending on search type, thereby improving the efficiency of searching for the map data.

In addition, because data structure information for a binary search tree structure is configured using a minimum number of fields, the size of the data structure information loaded into the sub memory 122 together with map data may be minimized. Because data structure information is configured while minimizing the size of data included in the data structure information, the search engine 121 may manage a part of information necessary for operations by using a buffer memory 123 located inside or outside the search engine 121.

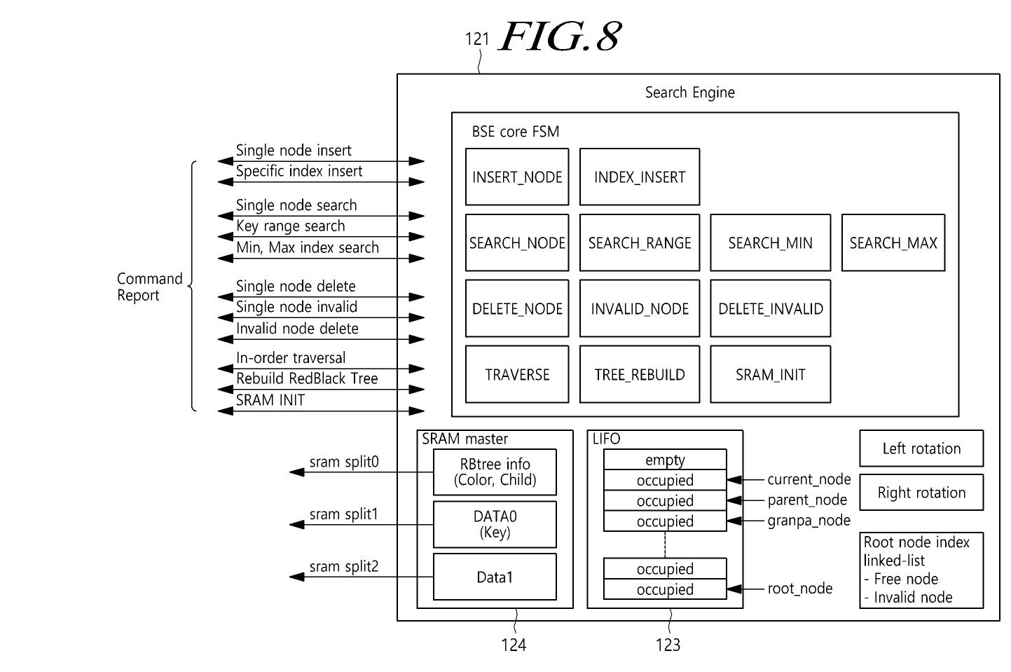

FIG. 8 is a diagram illustrating an example of a structure of a search engine according to embodiments of the present disclosure.

Referring to FIG. 8, a search engine 121 may include a logic that defines various operation states for managing, searching for, etc. data structure information. The search engine 121 may include a sub memory 122 (not illustrated) that has a LIFO stack structure. FIG. 8 illustrates as an example a case where the sub memory 122 used by the search engine 121 to load map data is SRAM, and the search engine 121 may include an SRAM master 124 for controlling the SRAM.

The search engine 121 may control operations for managing and searching for data structure information corresponding to map data according to various commands inputted from the outside. For example, the search engine 121 may perform operation control according to a command received from a host device 200, and may perform operation control according to a command generated by the control logic of a controller 120.

The search engine 121 may control, for example, an operation of inserting a node or an index according to a command. The search engine 121 may control an operation of adding a new node to data structure information configured with a binary search tree according to a command. The new node may be added to the data structure information depending on a value (e.g., a logical address) according to the node. The search engine 121 may control an operation of adding a specific index to data structure information configured with a binary search tree according to a command. The new node may be added to a determined position in the binary search tree depending on an index.

In another example, the search engine 121 may control an operation of searching for map data according to a command. The search engine 121 may control an operation of searching for a specific node according to a command. The search engine 121 may control an operation of searching for a node included in a certain range of nodes according to a command. The search engine 121 may control an operation of searching for a maximum value or a minimum value according to a command.

In a search operation, the search engine 121 may store information on the parent node of each node in a buffer memory 123. For example, the search engine 121 may store the parent node, the grandpa node, etc. of a current node in the buffer memory 123, according to search order, during a process of searching from a root node to the current node. Since the search engine 121 stores and manages information on the parent node of the current node in the buffer memory 123, the data structure information of each node does not need to include a field for information on parent node. The size of the data of the data structure information loaded into the sub memory 122 may be minimized.

In another example, the search engine 121 may control an operation of deleting or invalidating data structure information according to a command. The search engine 121 may control an operation of deleting data structure information or map data corresponding to the data structure information according to a command. The search engine 121 may control an operation of invalidating data structure information according to a command. The search engine 121 may invalidate data structure information by changing the value of the validity field included in the data structure information. The search engine 121 may update data structure information without changing or deleting the binary search tree structure of the data structure information or map data corresponding to the data structure information that is to be invalidated. The search engine 121 may control an operation of deleting invalidated data structure information according to a command.

In addition to the examples described above, the search engine 121 may control various operations for managing, searching for, setting, etc. data structure information and map data. The search engine 121 may control the traversal operation of a binary search tree. The binary search tree has a red-black tree structure, and an operation of updating data structure information to conform to the rules of the red-black tree structure may be performed. The search engine 121 may also control an operation of rebuilding a binary search tree, and may also control an operation of initializing the sub memory 122 into which data structure information and map data are loaded.

The SRAM master 124 may access data stored in the sub memory 122 under the control of the search engine 121. For example, the SRAM master 124 may access, in the sub memory 122, the first data area 122a where data structure information is stored, an area corresponding to split #1 and an area corresponding to split #2 in the second data area 122b where map data is stored, and may control data stored in each area.

Through the above-described operation controls, the search engine 121 may minimize the size of data structure information loaded into the sub memory 122, may efficiently manage the data structure information, and may improve search and management performance for map data corresponding to the data structure information.

The detailed processes of insertion, search and deletion operations corresponding to main operations among the operations controlled by the search engine 121 may be as follows.

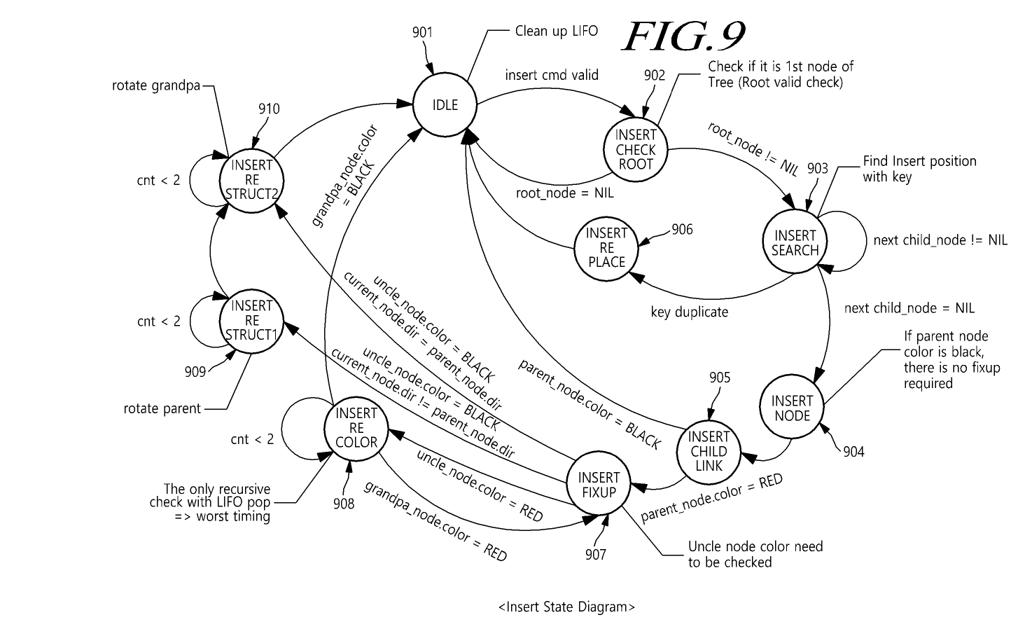

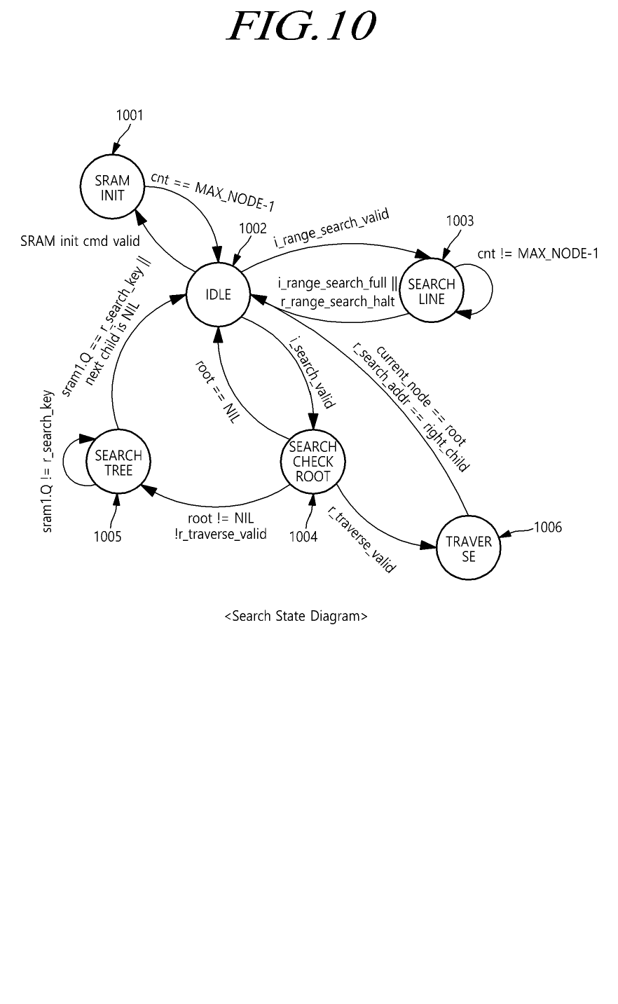

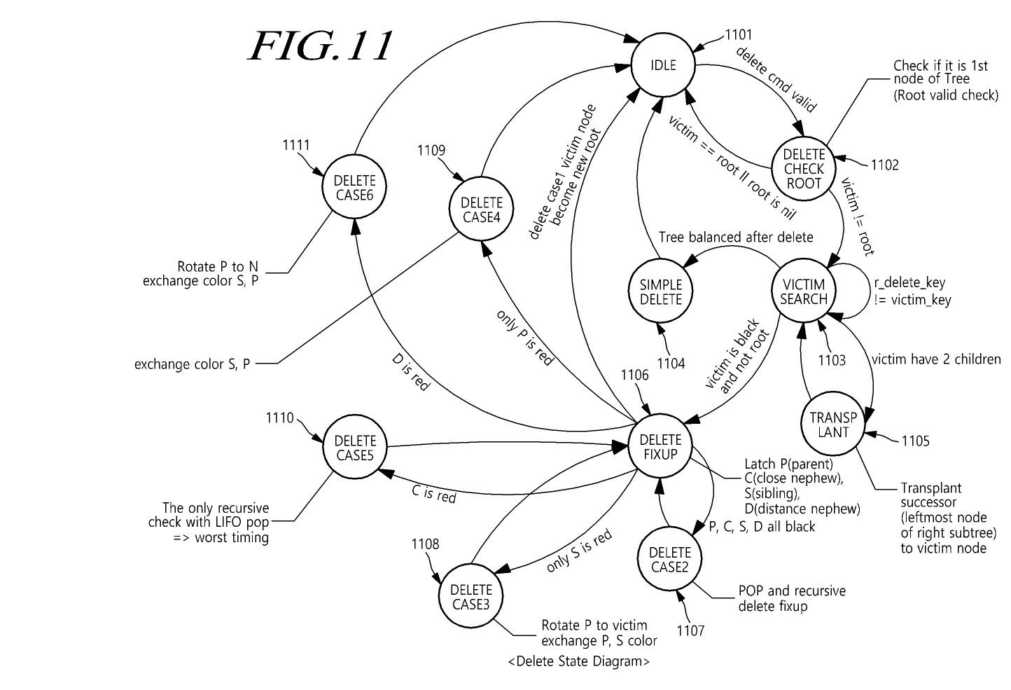

FIG. 9 is a diagram illustrating an example of a state related to an operation in which a search engine inserts a node into a data structure according to embodiments of the present disclosure. FIG. 10 is a diagram illustrating an example of a state related to an operation in which a search engine searches for a node in a data structure according to embodiments of the present disclosure. FIG. 11 is a diagram illustrating an example of a state related to an operation in which a search engine deletes a node from a data structure according to embodiments of the present disclosure.

Referring to FIG. 9, in an idle state indicated by 901, a search engine 121 may be in a state in which a buffer memory 123 is empty. When a valid insertion command signal is generated, the search engine 121 may receive a key for a binary search tree and stored data if necessary. The search engine 121 may transition to INSERT CHECK ROOT state indicated by 902. The received key and data may be latched.

When there is no root node (when a root node is a leaf node), the search engine 121 may insert a root node and complete an operation. When there is a root node, the search engine 121 may transition to INSERT SEARCH state as indicated by 903 and read the key of the root node.

The search engine 121 may continuously search a left child node (a first child node) when an inserted key is smaller than the key of a read node or a right child node (a second child node) when the inserted key is larger than the key of a read node, until a key value is a duplicate or a next child node becomes a leaf node. Each time the search engine 121 goes down a tree level through search, the search engine 121 may record the color, key, left node (first child node), right node (second child node) and self-pointer information of a current node in the buffer memory 123. When a key value is a duplicate, the search engine 121 may transition to INSERT REPLACE state as indicated by 906, and then, may complete an operation by replacing or invalidating the key value according to a setting.

When the search engine 121 finds an insert position where a leaf node has appeared, the search engine 121 may transition to INSERT NODE state indicated by 904, may record information on a new node in the sub memory 122 and the buffer memory 123, and then, may transition to INSERT CHILD LINK state indicated by 905. The color of the new node may be fixed to red.

The search engine 121 may update the information on the new node to the child node information of a parent node. At this time, when the color of the parent node is black, the insertion operation may be completed because the rules of a red-black tree are not violated. When the color of the parent node is red and the red-black tree is out of balance, the search engine 121 may transition to INSERT FIXUP state as indicated by 907 and perform rebalancing. When transitioning to the INSERT FIXUP state, the search engine 121 may prepare for rebalancing by reading an uncle node from the sub memory 122.

When the color of the uncle node is red, the search engine 121 may transition to INSERT RECOLOR state indicated by 908 while changing the color of the uncle node to black. When the color of the uncle node is black and the insertion directions of the new node and the parent node are different, the search engine 121 may transition to INSERT RESTRUCT1 state indicated by 909. When the color of the uncle node is black and the insertion directions of the new node and the parent node are the same, the search engine 121 may transition to INSERT RESTRUCT2 state as indicated by 910. Since there is a rotation process in the case of INSERT RESTRUCT1 and INSERT RESTRUCT2, the search engine 121 may store, in a register, three types of information such as an R node (a rotation reference node), a P node (the parent node of the R node) and a C node (the existing new node in the case of INSERT RESTRUCT1 and the existing P node in the case of INSERT RESTURCT2) where a change in color or child node information occurs. Operations in the above-described INSERT RECOLOR, INSERT RESTURCT1 and INSERT RESTRUCT2 may be performed in the same way as an operation for rebalancing in the red-black tree structure.

The search engine 121 may search for a node according to the linear search mode or the binary search mode in a state in which the node is inserted according to the red-black tree structure. The search engine 121 may search for a node according to the linear search mode when a command to search for a certain range is received. The search engine 121 may search for a node according to the binary search mode when a command to search for a single node is received.

For example, referring to FIG. 10, when an initialization command for the sub memory 122 is received in IDLE state indicated by 1002, the search engine 121 may transition to SRAM INIT state indicated by 1001. When a range search command is received, the search engine 121 transitions to SEARCH LINE state indicated by 1003, and may search for a node in the linear search mode.

When a single node search command is received, the search engine 121 may transition to SEARCH CHECK ROOT state indicated by 1004, and may check the information of a root node and then latch a search key. When there is no root node, the search engine 121 may transmit an error report as an empty tree, and may stop searching. When there is a root node, the search engine 121 may read information on the root node from the sub memory 122, and may transition to SEARCH TREE state indicated by 1005.

The search engine 121 may perform a search by following the child nodes of a tree until a key value read from the sub memory 122 is the same as the latched search key. When key values do not match during the search and a child node is a leaf node, the search engine 121 may report that there is no search result. When key values match during the search, the search engine 121 may report the index (SRAM pointer), key and data value of a corresponding node.

The search engine 121 may support at least a part of the three types (in-order, pre-order and post-order) of traversal of the binary search tree, and, for example, may support in-order traversal. The search engine 121 may transition to TRAVERSE state as indicated by 1006, and perform a traversal operation.

The search engine 121 may invalidate or delete a node according to an invalidation or deletion command. For example, when receiving an invalidation command, the search engine 121 may change the value of the validity field of the data structure information of a corresponding node and invalidate the corresponding node. Due to deletion of the node, it is possible to prevent or reduce frequent occurrence of a rebalancing or traversal operation, and improve map data management and search performance using a red-black tree structure. The search engine 121 may control an operation of deleting a corresponding node according to a deletion command.

For example, referring to FIG. 11, when a deletion command is received in IDLE state indicated by 1101, the search engine 121 may transition to DELETE CHECK ROOT state indicated by 1102. When a deletion-requested victim node is a root node and the root node is a leaf node, the search engine 121 may delete the root node and end an operation.

When a deletion-requested victim node is not a root node, the search engine 121 may transition to VICTIM SEARCH state as indicated by 1103. The search engine 121 may move a successor node to the victim node to delete the victim node.

When the victim node has only one child node, the search engine 121 may transition to SIMPLE DELETE state as indicated by 1104, may move a corresponding child node to the position of the victim node, may set the color of the child node to black, and may complete a deletion operation.

When the victim node has two child nodes that are not leaf nodes, the search engine 121 may transition to TRANSPLANT state as indicated by 1105, may designate a smallest node in a right sub tree as a successor node, may place the successor node to the position of the victim node, and may maintain the color of the successor node to be the same as the color of the victim node.

When the victim node has no child node but is black in color, the search engine 121 may delete the victim node and then transition to DELETE FIXUP state indicated by 1106. The search engine 121 may latch four nodes to proceed with a next process. The four nodes may be a parent node (a P node), a sibling node (an S node), a distant nephew node (a DN node) and a close nephew node (a CN node). The search engine 121 may transition between states depending on the colors of the four nodes.

For example, when the colors of the P node, the S node, the DN node and the CN node are all black, the search engine 121 may transition to DELETE CASE2 state indicated by 1107. When the colors of the P node, the DN node and the CN node are black and the color of the S node is red, the search engine 121 may transition to DELETE CASE3 state indicated by 1108. When the color of the P node is red and the colors of the S node, the DN node and the CN node are black, the search engine 121 may transition to DELETE CASE4 state indicated by 1109. When the colors of the P node and the CN node are red and the colors of the S node and the DN node are black, the search engine 121 may transition to DELETE CASE5 state indicated by 1110. When the colors of the P node and the DN node are red and the colors of the S node and the CN node are black, the search engine 121 may transition to DELETE CASE6 state indicated by 1111.

The deletion operation of the search engine 121 described above is only an example, and a deletion operation may be performed by adjusting the structure of a red-black tree depending on a scheme in which a node is deleted in the red-black tree structure.

The search engine 121 may perform an operation of deleting a node according to a deletion operation of a red-black tree structure, and may adjust time points at which an operation of deleting a normal node, an operation of deleting an invalidated node and a rebalancing or traversal operation of a binary search tree structure are performed, by changing the value of the validity field in the data structure information of each node.

In this way, the search engine 121 may improve search performance for map data by loading data structure information corresponding to the map data into the sub memory 122 and using the data structure information when searching for the map data. In addition, by minimizing the size of data structure information loaded into the sub memory 122 and adjusting a time point, a period, etc. of performing an operation for management of a binary search tree, it is possible to prevent or minimize performance deterioration due to the use of the data structure information.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A storage device comprising:
a memory including a plurality of storage areas, each of the plurality of storage areas indicated by a physical address; and
a controller configured to load a map data representing a mapping relationship between the physical address and a logical address provided by a host device and data structure information corresponding to the map data into a sub memory, and to search for the map data using the data structure information, which includes a validity field that has a value indicating whether the map data is valid.

2. The storage device according to claim 1, wherein the data structure information includes a type field that has a value indicating a type of the data structure information, a first pointer field that has a first pointer value associated with the data structure information, and a second pointer field that has a second pointer value associated with the data structure information.

3. The storage device according to claim 2, wherein the first pointer value indicates an address of a sub memory of the data structure information including the first pointer field, and the second pointer value indicates an address of a sub memory of next data structure information.

4. The storage device according to claim 2, wherein the first pointer value indicates an address of a sub memory of a first child node of the data structure information including the first pointer field, and the second pointer value indicates an address of a sub memory of a second child node of the data structure information including the second pointer field.

5. The storage device according to claim 4, wherein the first pointer value and the second pointer value included in at least one of the data structure information are the same.

6. The storage device according to claim 4, wherein when the type field included in the data structure information has a first value, type fields included in data structure information of the first child node indicated by the first pointer value of the data structure information and the second child node indicated by the second pointer value have a second value.

7. The storage device according to claim 4, wherein when the type field included in the data structure information has a first value, type fields included in data structure information of a parent node of the data structure information and a child node of the data structure information have a second value.

8. The storage device according to claim 1, wherein
the controller, when performing a search using the data structure information, sequentially stores addresses of the sub memory indicating the data structure information in a buffer memory, and
the buffer memory has a LIFO (last input first out) stack structure.

9. The storage device according to claim 1, wherein the sub memory includes a first data area and a second data area, the data structure information is stored in the first data area, and the map data is stored in the second data area.

10. The storage device according to claim 9, wherein the controller updates at least a part of the data structure information by accessing the first data area, and the map data, corresponding to the updated data structure information and stored in the second data area, is maintained unchanged.

11. The storage device according to claim 1, wherein the controller, when receiving an invalidation command or a deletion command on at least one of the map data, changes the value of the validity field from a first value to a second value.

12. The storage device according to claim 11, wherein the controller updates the data structure information during a preset period, and the data structure information in which the value of the validity field is the second value according to the update and the map data corresponding to the data structure information are removed.

13. The storage device according to claim 1, wherein the controller performs, when searching for single map data, a search in a binary search mode using the data structure information, and performs, when searching for map data included in a range of the map data, a search in a linear search mode using the data structure information.

14. A storage device comprising:
a first memory including a plurality of storage areas indicated by physical addresses;
a second memory including a first data area and a second data area, wherein data structure information having at least one pointer value is stored in the first data area and map data, corresponding to the data structure information and including the physical addresses, is stored in the second data area; and
a controller configured to search for the map data using the data structure information.

15. The storage device according to claim 14, wherein the data structure information includes a type field that has a value indicating a type of the data structure information, a validity field that has a value indicating whether the map data is valid, a first pointer field that has a first pointer value associated with the data structure information, and a second pointer field that has a second pointer value associated with the data structure information.

16. The storage device according to claim 15, wherein the first pointer value and the second pointer value indicate an address of a sub memory of the data structure information.

17. The storage device according to claim 14, wherein the controller stores the data structure information, and the map data stored in the second memory, in a storage area designated from among the plurality of storage areas included in the first memory.

18. A controller comprising:
a sub memory including a first data area and a second data area, wherein data structure information having at least one pointer value is stored in the first data area and map data corresponding to the data structure information is stored in the second data area; and
a search engine configured to search for the map data using the data structure information.

19. The controller according to claim 18, wherein the map data includes a physical address included in a memory located outside of the controller.

20. The controller according to claim 18, wherein the search engine searches for single map data by searching the data structure information in a binary search mode, and searches for map data included in a range of the map data by searching the data structure information in a linear search mode.
